(19) United States
(12) Patent Application Publication
(10) Pub. No.: US 2011/0045452 A1
(43) Pub. Date: Feb. 24, 2011

(54) Computer-Implemented Systems and Methods for Generating an Adaptive Test

(76) Inventors: Isaac I. Bejar, Hamilton, NJ (US); Edith Aurora Graf, Lawrenceville, NJ (US)

Correspondence Address: JONES DAY, 222 EAST 41ST ST, NEW YORK, NY, 10017, US

(21) Appl. No.: 12/861,862

(22) Filed: Aug. 24, 2010

Related U.S. Application Data
(60) Provisional application No. 61/236,319, filed on Aug. 24, 2009.

(51) Int. Cl. G09B 7/00

(52) U.S. Cl. 434/362

(57) ABSTRACT

Systems and methods are provided for assigning an examinee to one of a plurality of scoring levels based on an adaptive exam that generates one or more questions of the exam subsequent to the start of administration of the exam to the examinee. A first exam question is provided to the examinee and a first exam answer is received from the examinee. The first exam question requests a constructed response from the examinee. A score for the first exam answer is generated, and a second exam question is generated, where the difficulty of the second exam question is based on the score for the first exam answer. The examinee is assigned to one of a plurality of scoring levels, where the examinee is excluded from assignment to one or more of the plurality of scoring levels based on the first exam answer without consideration of the second exam answer.

### CROSS REFERENCE TO RELATED APPLICATIONS

This application claims priority to U.S. Provisional Application No. 61/236,319, filed Aug. 24, 2009, entitled “Form Models Implemented into an Adaptive Test,” the entirety of which is herein incorporated by reference.

### FIELD

The technology described herein relates generally to test generation and more specifically to generation of adaptive tests.

### BACKGROUND

Accountability theory is a rational approach to improving the educational status of a nation. Accountability theory includes a set of goals the educational system wishes to achieve, a set of measures to assess how well those goals are met, a feedback loop for forwarding information to decision makers, such as teachers and administrators, based on those measures, and a systemic change mechanism for acting on the feedback and changing the system as necessary to achieve the goals.

Recent legislation has established a goal of achieving high levels of proficiency in a number of subject areas. Progress toward that goal is assessed every year at consecutive grade levels. Content standards define what an examinee should know, and achievement standards define how much an examinee should know. Tests (“exams”) are designed to determine how well an examinee measures up to these standards, and examinees are categorized according to their performance on the designed tests. The present inventors have observed a need for improving testing and assessment of examinees through better adaptive testing.

### SUMMARY

Systems and methods are provided for assigning an examinee to one of a plurality of scoring levels based on an adaptive exam that generates one or more questions of the exam subsequent to the start of administration of the exam to the examinee. A first exam question may be provided to the examinee and a first exam answer is received from the examinee. The first exam question may request a constructed response from the examinee. A score for the first exam answer may be generated, and a second exam question may be generated, where the difficulty of the second exam question is based on the score for the first exam answer. The examinee may be assigned to one of a plurality of scoring levels, where the examinee is excluded from assignment to one or more of the plurality of scoring levels based on the first exam answer without consideration of the second exam answer.

As another example, a computer-implemented method of assigning an examinee to one of a plurality of scoring levels based on an adaptive exam that generates one or more questions of the exam subsequent to the start of administration of the exam to the examinee may include providing a first exam question to the examinee and receiving a first exam answer from the examinee, where the first exam question requests a constructed response from the examinee and where the first exam answer is a constructed response. A score for the first exam answer may be generated, and a second exam question may be generated subsequent to receiving the first exam answer, where a difficultly of the second exam question is based on the score for the first exam answer. The second exam question may be provided to the examinee, a second exam answer may be received from the examinee, and a score may be generated for the second exam answer. The examinee may then be assigned to one of the plurality of scoring levels based on the score for the first exam answer and the score for the second exam answer.

As another example, a computer-implemented system of assigning an examinee to one of a plurality of scoring levels based on an adaptive exam that generates one or more questions of the exam subsequent to the start of administration of the exam to the examinee may include a processor and a computer-readable memory encoded with instructions for commanding the processor to execute steps of a method that includes providing a first exam question to the examinee and receiving a first exam answer from the examinee, where the first exam question requests a constructed response from the examinee and where the first exam answer is a constructed response. A score for the first exam answer may be generated, and a second exam question may be generated subsequent to receiving the first exam answer, where a difficultly of the score for the second exam question is based on the score for the first exam answer. The second exam question may be provided to the examinee, a second exam answer may be received from the examinee, and a score may be generated for the second exam answer. The examinee may then be assigned to one of the plurality of scoring levels based on the score for the first exam answer and the second exam answer.

As a further example, a computer-readable memory may be encoded with instructions for commanding a processor to execute steps of a method that includes providing a first exam question to the examinee and receiving a first exam answer from the examinee, where the first exam question requests a constructed response from the examinee and where the first exam answer is a constructed response. A score for the first exam answer may be generated, and a second exam question may be generated subsequent to receiving the first exam answer, where a difficultly of the second exam question is based on the score for the first exam answer. The second exam question may be provided to the examinee, a second exam answer may be received from the examinee, and a score may be generated for the second exam answer. The examinee may then be assigned to one of the plurality of scoring levels based on the score for the first exam answer and the score for the second exam answer.

### BRIEF DESCRIPTION OF THE DRAWINGS

FIG. 1 depicts a computer-implemented environment for assigning an examinee to one of a plurality of scoring levels.

FIG. 2 is a block diagram depicting an example system configuration for providing an adaptive exam to a user.

FIG. 3 is a block diagram depicting interactions among an adaptive test generator, a user terminal, and a user.

FIG. 4 is a flow diagram depicting an example adaptive examination that may be provided by an adaptive test generator.

FIG. 5 is a block diagram depicting an adaptive test generator.

FIG. 6 depicts an example item model.

FIG. 7 depicts an example form model.

FIG. 8 depicts data tables used in an example optimization.

FIG. 9 is a block diagram depicting an adaptive test generator providing and generating exam questions.

FIG. 10 depicts a computer-implemented method of assigning an examinee to one of a plurality of scoring levels based on an adaptive exam that generates one or more questions of the exam subsequent to the start of administration of the exam to the examinee.

FIGS. 11A, 11B, and 11C depict example systems for an adaptive test generator.

### DETAILED DESCRIPTION

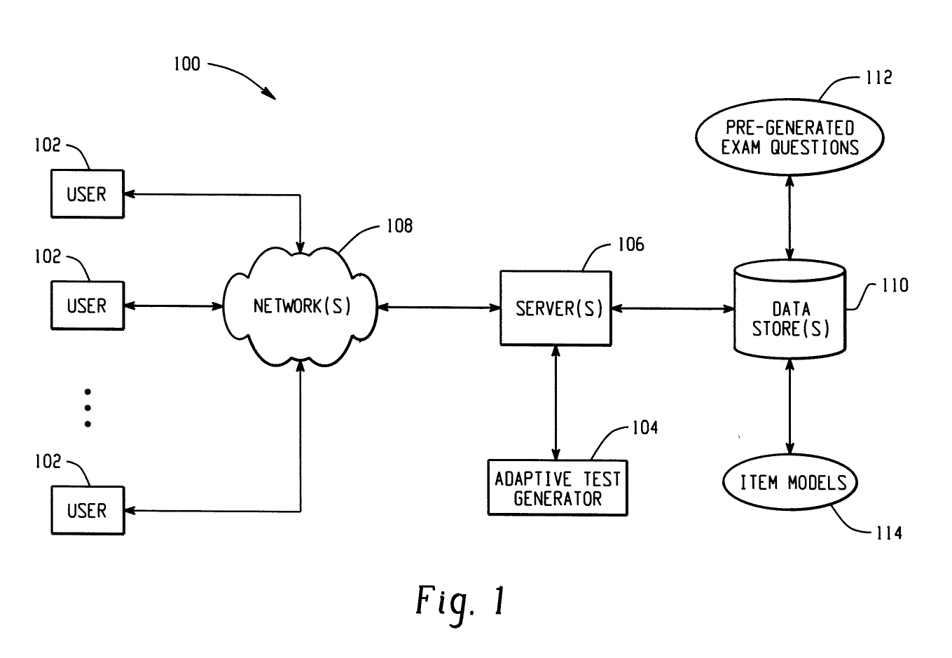

FIG. 1 depicts at 100 a computer-implemented environment of assigning an examinee to one of a plurality of scoring levels. A user (test designer) 102 interacts with an adaptive test generator 104 to generate and administer an adaptive test to an examinee. An example adaptive test generator 104 may employ a multi-stage adaptive test with features that can meet the often competing demands of accountability assessments. The features can include on-the-fly item generation, constructed response technologies, and automated scoring. Content blueprints or test blueprints may make use of optimization theory to yield scores with maximal decision consistency. Cutscores for classifying examinees into a particular level are considered at the time of test generation. Cutscores as referred to herein includes scores that separate test takers into various categories. Optimization theory as referred to herein includes methodology for deciding on specific solution or solutions in a set of possible alternatives that will best satisfy a selected criterion, such as linear programming, nonlinear programming, stochastic programming, control theory, etc.

By virtue of incorporating such procedures, methods, and concepts, the resulting test may have psychometric properties that are difficult to duplicate otherwise. That is, the test design can be optimal or near-optimal in a psychometric sense, i.e., in the sense of scores based on that design have desirable, specified attributes, such as that the conditional standard error of measurement be held at a certain value or that the assignment to levels of achievement reach a specified level of decision consistency compared to other possible designs.

Traditionally, cutscores are determined after a test has been designed. However, by failing to explicitly incorporate cutscores into the design of which items comprise the test, the opportunity to design an optimal test, given the set of items that is available to design the test, is lost. Given a database of previously calibrated items and a set of cutscores, which may be determined by any of a variety of methods, optimization theory can be applied to select the items that would yield scores with the desired optimal characteristics. The same design approach can be used when using item models in place of or in conjunction with pre-generated test items. An item model is a general procedure to generate items with specified psychometric characteristics. Traditionally, item generation during a test would be discouraged because conventional wisdom dictates that items should be pre-tested prior to administration to estimate those items' psychometric characteristics. Once an item model has been pre-tested, however, the present inventors have observed that an item model can be used to generate items that have known psychometric attributes without pre-testing each generated item.

Item models can be constructed to generate multiple-choice items or constructed response items. In the case of multiple choice items, the scoring may be accomplished using a lookup table. Adaptive tests have traditionally been limited to multiple choice or true/false questions, as responses to those types of questions can be quickly and accurately scored. According to approaches described herein, adaptive tests can also be generated to include questions requiring constructed responses. An exemplary adaptive test generator 104 may generate multiple choice test items and/or test items requesting a constructed response to be administered to an examinee. A question requesting a constructed response requires more than a single number or character response, such as a free-form response like a written or spoken phrase, sentence or paragraph, for instance. In the case of a constructed response, scoring has traditionally been done by human scorers. An example adaptive test generator 104 may perform automated scoring of constructed responses by utilizing a scoring engine in the form of a software module implementing suitable scoring approaches such as described elsewhere herein. The scoring engine may return a score in near real time because scores for each item in an adaptive test need to be known to make such adaptations possible.

The users 102 can interact with the adaptive test generator 104 through a number of ways, such as over one or more networks 108. Server(s) 106 accessible through the network(s) 108 can host the adaptive test generator 104. One or more data stores 110 can store the data to be analyzed by the adaptive test generator 104 as well as any intermediate or final data generated by the adaptive test generator 104. The one or more data stores 110 may contain many different types of data associated with the process, including pre-generated exam questions 112, item models 114, as well as other data. The adaptive test generator 104 can be an integrated web-based reporting and analysis tool that provides users flexibility and functionality for generating and administering an adaptive test. It should be understood that the adaptive test generator 104 could also be provided on a stand-alone computer for access by a user 102.

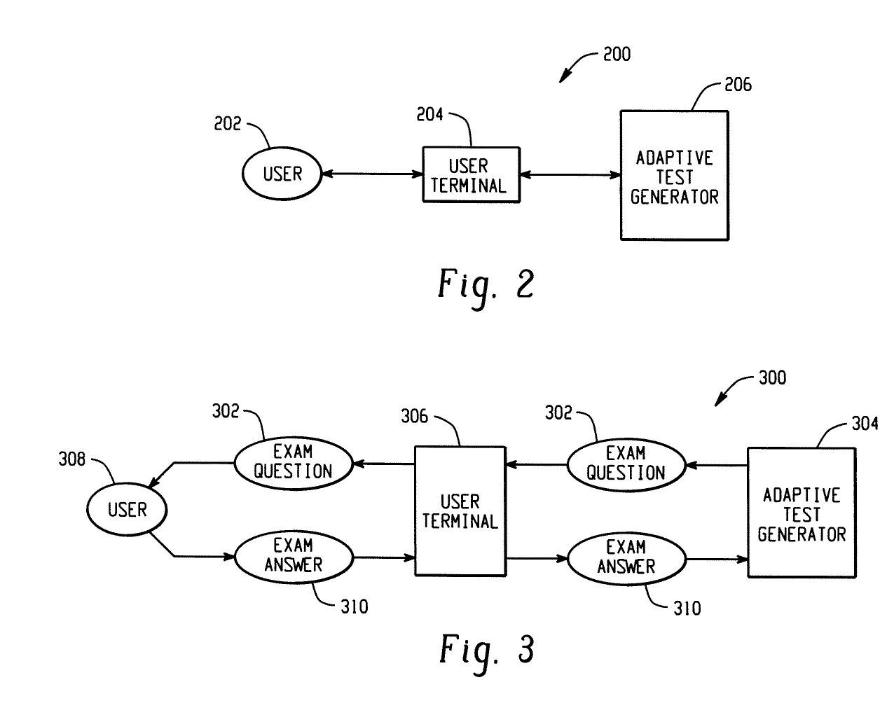

FIG. 2 is a block diagram depicting an example system configuration for providing an adaptive exam to a user (“examinee”). A user 202 interacts with a user terminal 204 that further interacts with an adaptive test generator 206. The example configuration can take a variety of forms and be provided in a variety of settings. For example, the user terminal 204 may be one of several terminals located at a test taking facility. The user 202 travels to the test taking facility and takes the exam on the user terminal 204. As another example, the user terminal 204 could be a personal computer of the user 202 that utilizes a web browser to provide the exam to the user 202, such that the user is able to take the exam from his home or other location as desired, should the rules of the exam allow. The adaptive test generator 206 may be provided in a number of locations, such as locally at a test taking facility, at a remotely located server, or even on the same computing machine as the user terminal 204.

FIG. 3 is a block diagram depicting interactions among an adaptive test generator, a user terminal, and a user. Exam questions 302 are transmitted from the adaptive test generator 304 to the user terminal 306 which are further relayed to the user 308 for display, such as via a display device. The user 308 responds to the provided exam question 302 using an input device of the user terminal 306 to generate an exam answer 310. The user terminal 306 provides the exam answer 310 to the adaptive test generator 304, which generates the score for the received exam answer. The adaptive test generator 304 then provides a further exam question based on the score generated for the first exam answer. For example, if the user 308 provides a correct answer to an exam question or scores sufficiently high on a series of exam questions, the next exam question or number of exam questions provided by the adaptive test generator 304 may be more difficult than the earlier exam question or questions. Alternatively, if the user 308 provides an incorrect answer to an exam question or does not score sufficiently high on a series of exam questions, the next exam question or number of exam questions provided by the adaptive test generator 304 may be less difficult than the earlier exam question or questions.

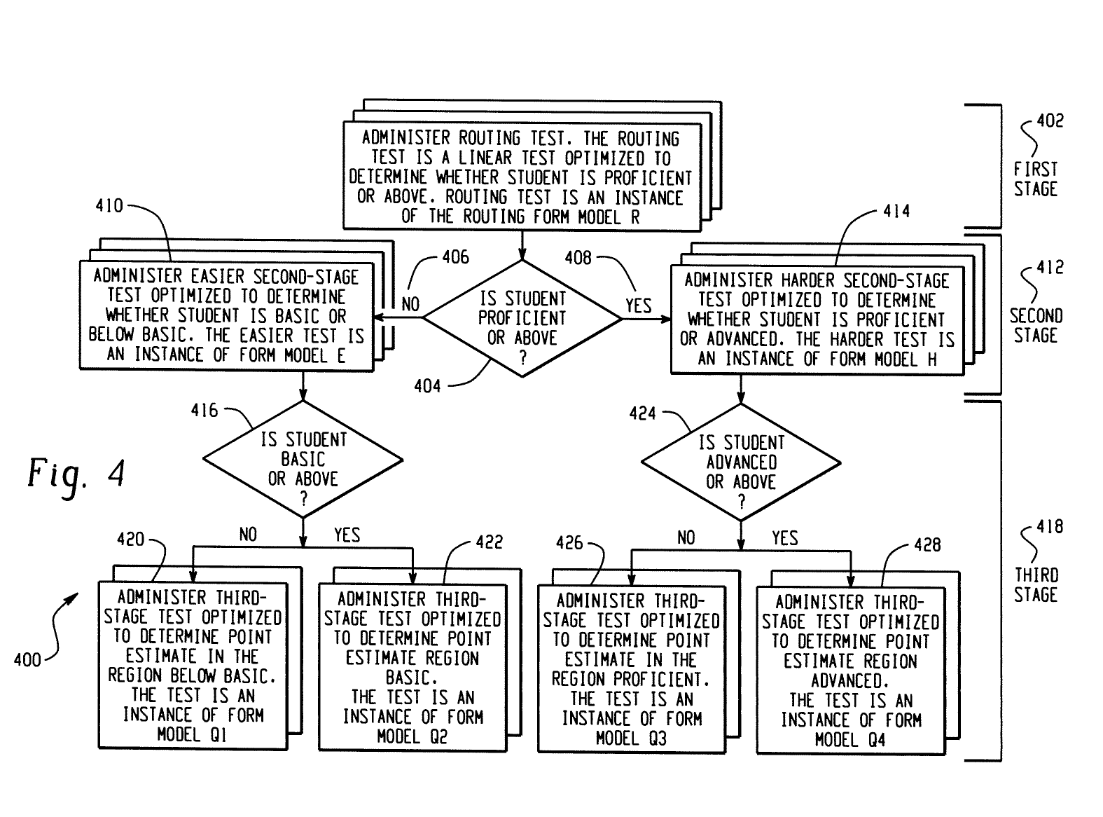

FIG. 4 is a flow diagram depicting an example adaptive examination that may be provided by an adaptive test generator according to one example. The first stage 402 of the adaptive examination includes a routing test, R. The routing test may be a linear test that is optimized to determine whether a student is proficient or above at a subject area of interest. For example, the routing test may include questions that would be correctly answered by an examinee that is proficient at a subject matter being tested and would be answered incorrectly by an examinee that is not proficient at the subject matter being tested. Based on the one or more questions of the routing test administered in the first stage 402, the examinee is routed at 404 to a less than proficient branch 406 or a proficient or above branch 408.

For an examinee routed to the less than proficient branch 406, an easier test 410, E, is administered during the second stage 412. The easier second stage test 410 is optimized to determine whether an examinee is basic or below basic levels. Based on the one or more questions of the easier second stage test 410, the examinee is further classified at 416. The further classification at 416 may provide a final assignment of the examinee to one of a plurality of scoring levels or bins based on the examinee's performance at the first stage 402 and the second stage 412. Alternatively, as depicted in FIG. 4, the examinee may be provided questions in a third stage 418 to further classify the examinee within the below basic level at 420 or the basic level at 422.

For an examinee routed to the proficient or above branch 408, a harder test 414, H, is administered during the second stage 412. The harder second stage test 414 is optimized to determine whether an examinee is proficient or advanced. Based on the one or more questions of the harder second stage test 414, the examinee is further classified at 424. The further classification at 424 may provide a final assignment of the examinee to one of a plurality of scoring levels or bins based on the examinee's performance at the first stage 402 and the second stage 412. Alternatively, as depicted in FIG. 4, the examinee may be provided questions in a third stage 418, to further classify the examinee within the proficient level at 426 or the advanced level at 428.

Multi-stage adaptive testing, consisting or fixed or variable length blocks, as described further herein, is a specific variety of adaptive testing that selects one item or set of items at a time and administers short forms of a level of difficulty based on the student's previous performance. When the goal of an exam is to divide students into a plurality of levels, a reasonable logic in constructing an adaptive test is to take those levels into account to maximize the consistency of proficient classifications. R, the routing test, therefore needs to be designed with that in mind. Ideally, the other classifications are equally consistent but not at the expense of consistency of the proficient classification. A variable-length approach may also be utilized.

Traditionally, the cutscores that define the achievement levels are not known ahead of time and, therefore, cutscores are typically not seen as design factors. However, the present inventors have determined that the cutscores or close approximations of those cutscores can be established as operational parameters at the design stage to ensure that the assessment eventually produced is optimal for the task at hand, e.g., classifying students into achievement levels based on the assessment policy. The cutscores can be determined during the design process or by a preliminary administration, for example. Having the cutscores for the various achievement levels defined during the development process can ensure “an adequate exercise pool” because the psychometric attributes of the items to be produced are known prior to the start of the item production process, which translates to ensuring accurate and consistent classifications.

A further consideration is the item format. The assessment described in FIG. 4 may accommodate a mixture of multiple choice and constructed response items, either of those being scored dichotomously and polytomously. Polytomously and dichotomously scored items may be used to classify students into one of several achievement level classifications.

Another consideration is the nature of the decision rule for assigning second stage tests. As noted above, the routing test may be optimized to classify students into proficient-or-above and below-proficient levels. One approach to implementing a routing decision is to estimate ability or proficiency on the statistical attributes of the items responded to at the end of the routing test and assign form H if the estimate exceeds the cutscore for proficient. Alternatively, a sumscores could be computed, which can be as effective as more complex routing rules that utilize the estimation of ability.

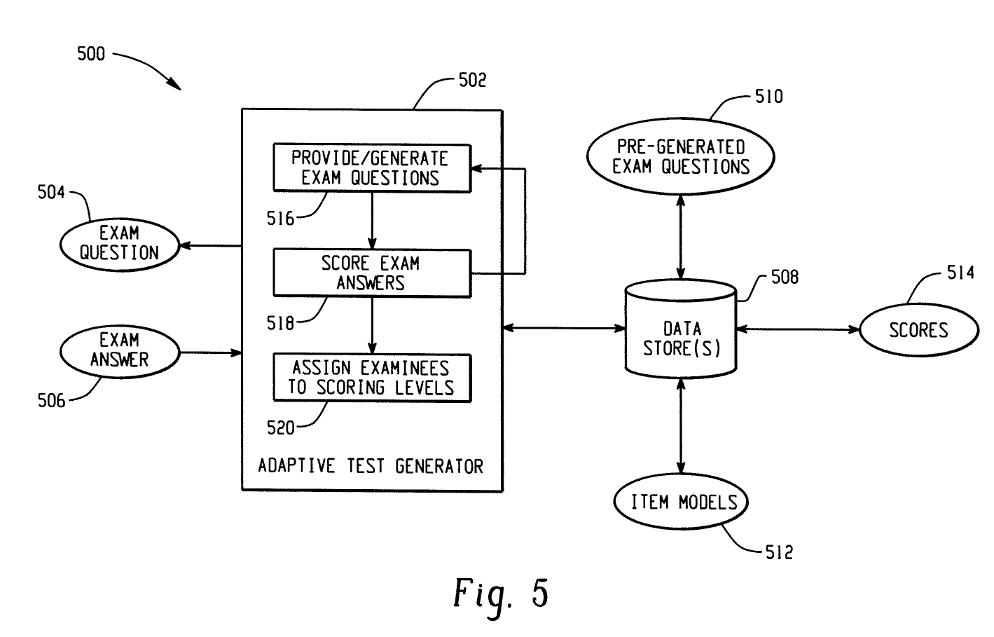

FIG. 5 is a block diagram depicting an exemplary adaptive test generator 502. The adaptive test generator 502 outputs exam questions 504 and receives exam answers 506. The adaptive test generator 502 may be responsive to one or more data stores 508. The one or more data stores 508 may contain a variety of data including pre-generated exam questions 510 and item models 512 for generating additional exam questions. The one or more data stores 508 may also store scores 514 representing examinee performance on an exam. For example, the one or more data stores 508 may contain an examinee's scores for individual questions or overall scores representing an examinee's performance on an entire exam.

The adaptive test generator 502 may perform a variety of functions. For example, the adaptive test generator may provide and/or generate exam questions, as depicted at 516. The exam questions utilized by the adaptive test generator may be pre-generated exam questions 510, such as those stored in the one or more data stores 508, as well as items generated during the administration of an exam (on-the-fly).

Item generation can be a straightforward process of inserting values into variables of an item model or may be more complex. Item generation can include the production of items by algorithmic means in such a way that the psychometric attributes (e.g., difficulty and discriminating power) of the generated items are predictable rather than simply being mass produced with unknown psychometric attributes. Items that have similar psychometrics attributes are referred to as isomorphs. Another type of generated item, variants, differs predictably in some respect, such as difficulty. The distinction between isomorphs and variants is one of convenience in that it is possible to conceive of an item generation process that encompasses both cases where, for example, holding psychometrics attributes constant is a special case where “variants” are isomorphs.

Approaches for generating a large number of items algorithmically, such as described below, improves efficiency and cost effectiveness. Such algorithms should be capable of rendering items that include graphics—which are notoriously expensive to produce by conventional means. The availability of items that appear different to the examinee but have similar psychometric attributes is beneficial to test security because it is less feasible for examinees to anticipate the content of the test. This approach, in turn, makes it possible to create comparable forms and to administer effectively distinct and yet comparable forms for each individual test taker.

The dependability of student-level classifications can be reduced to the extent there is lack of isomorphicity because lack of isomorphicity becomes part of the definition of error of measurement. From generalizability theory it is known that if the objective of the assessment is to rank students, generalizability is given by

$$E {ρ}_{1}^{2} = \frac{{σ}^{2} ( p )}{{σ}^{2} ( p ) + {σ}^{2} ( δ )} ,$$

where σ² (δ) is composed of a subset of the sources of error variability. By contrast, when the measurement goal is to make categorical or absolute decisions, such as classifying students into achievement levels, dependability is given by

$$E {ρ}_{2}^{2} = \frac{{σ}^{2} ( p )}{{σ}^{2} ( p ) + {σ}^{2} ( Δ )} ,$$

where σ² (Δ) includes all sources of error variability, including lack of isomorphicity. In that case, σ² (Δ)>σ² (δ) and, therefore, Eρ₁²≧Eρ₂² to the extent there is lack of isomorphicity.

Similarly, from the item response theory (IRT) it is known that lack of isomorphicity is tantamount to the case where the same item has multiple item characteristics curves (icc's), one for each instance of an item model. Since it is not known ahead of time which instance will be presented, the expectation of the icc's is one representation of the multiple icc's that could be used as a parameterization of the item model. Expected response functions can be used for that purpose. To the extent the icc's for different instances differ in difficulty but have the same discriminating power (slope), the discriminating power of the expected response function will be less than the discriminating power of the individual instances. When estimating ability, the conditional standard error of measurement will be larger as a result because of the increased uncertainty. In short, lack of isomorphicity has a price, namely to reduce the certainty of estimates of test performance whether viewed from a generalizability or IRT perspective.

One effective mechanism for generating isomorphic items algorithmically and on-the-fly is an item model. Item models are oriented to producing instances that are isomorphic. Instances are the actual items presented to test takers. Item models can be embedded in an on-the-fly adaptive testing system so that the items are produced from item models at run time. Existing items may become the basis for construction of item models. The adaptive test generator 502 may instantiate items from an item model as needed during the adaptive item selection process.

When the goal is to produce isomorphs, a key step in the development process is verifying that the item model produces sufficiently psychometrically isomorphic instances, and that appear to be distinct items. In one example, the 3-PL item parameter estimates used typically in admission tests are obtained from experimental sections of the test devoted to pre-testing. The resulting parameter estimates are then used in the adaptive test. Those parameters may be attenuated by means of expected response functions. Fitting an expected response function to instances of an item model acknowledges the variability in the true parameters of the instances. This has the effect of attenuating or reducing the discriminating power of an expected response function as a function of the variability of the instances.

Item model development may begin by conducting a construct analysis by inspecting groups of items that measure similar skills. A set of source items is ultimately selected. Item models may be broadly or narrowly defined. Broadly-defined item models may be deliberately designed to generate instances that vary with respect to their surface characteristics, their psychometric characteristics, or both. Narrowly-defined item models are designed to generate instances that are isomorphic. Isomorphic instances vary with respect to their surface features, but they share a common mathematical structure and similar psychometric characteristics.

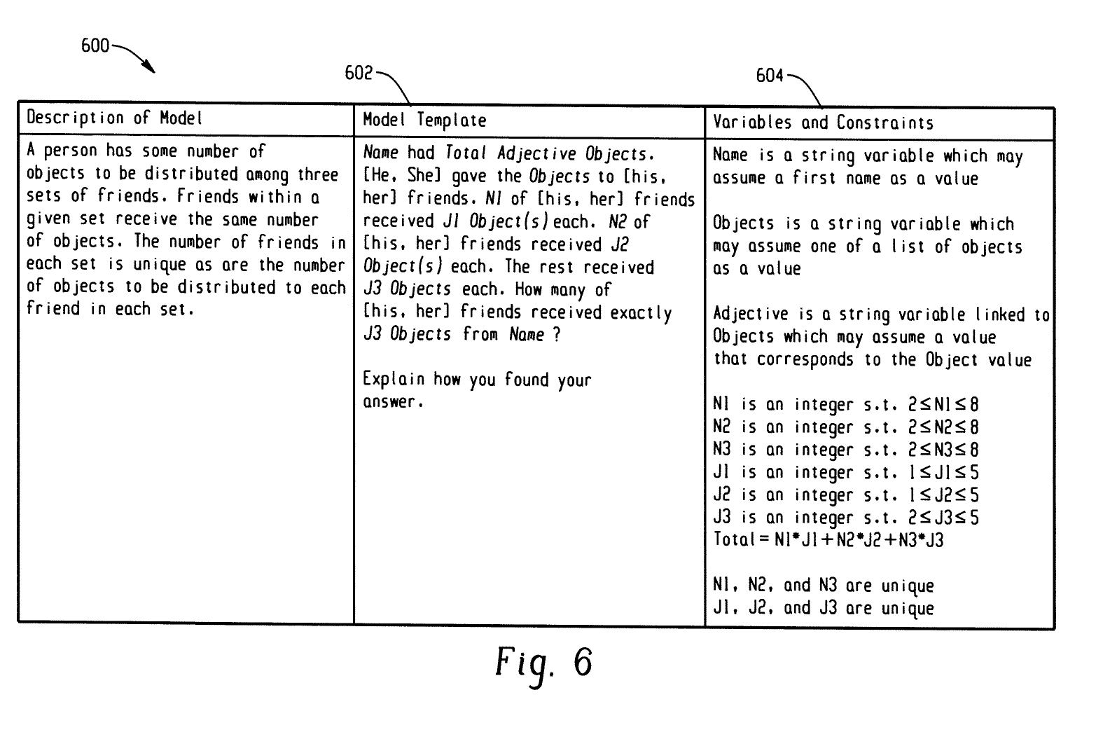

FIG. 6 depicts an example item model. The example item model includes a model template 602 that describes an exam question that requests a constructed response for a math question. The template 602 includes a number of variables, denoted as being in italics. The item model further includes a description of variables to be used in the model template 602 as well as constraints to be placed on those variables, such as for optimization, at 604.

With suitable design of the item models it is possible to generate sufficiently exchangeable or isomorphic items. A natural extension of this idea is the form model. A form model as referred to herein is an array of item models not unlike a test blueprint. However, a form model may go beyond a test blueprint in that a set of item models, rather than more general specifications, may define the form model. Forms generated from a form model may be parallel to the extent that the item models that comprise the form model can be written to generate sufficiently isomorphic instances or items. That is, the forms produced from a form model do not have to be explicitly equated because by design the scores from different forms are comparable. Extending that reasoning to the adaptive test depicted in FIG. 4, designing form models R, H and E is similar to of producing many two-stage adaptive tests that are comparable.

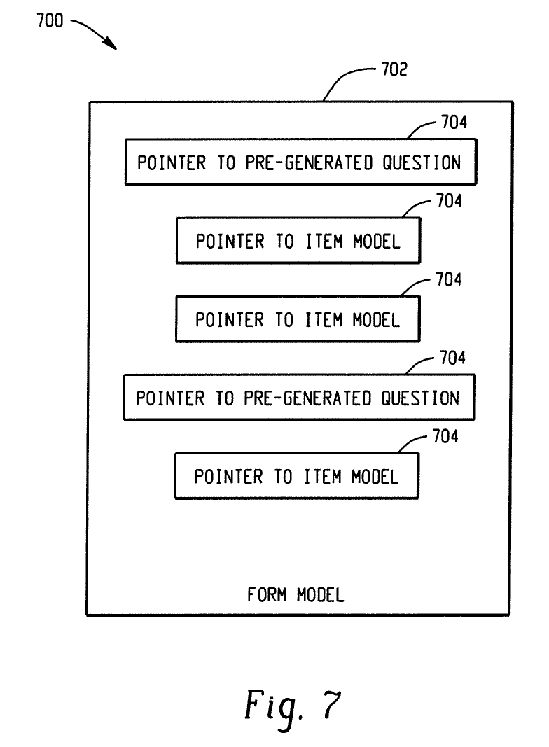

FIG. 7 depicts an example form model 702. A form model may be implemented in a variety of structures, such as an array structure, as described above. A form model 702 may also be implemented as a sequence of pointers 704 to pre-generated questions and item models for generating questions on-the-fly.

One design issue for tests intended to classify students is where to “peak” the information function. That is, where to concentrate the discriminating power of the test given the goal to classify students as consistently and accurately as possible, rather than obtain a point estimate of their ability. Peaking information at the cutscore leads to more consistent classification than peaking to the mean of the population.

Application of optimization theory utilizes explication of a design space, an objective function, and a set of constraints to formulate a form model. A design space as referred to herein is the array of candidate item models and information about each item model and can be represented as a matrix. The columns of the design space are attributes of the item models that are thought to be relevant to determining the objective function and satisfying the stated constraints. There is a column for each task attribute that will be considered in the design. The optimization design problem is finding a subset of the rows of the design space, a row corresponding to an item model or an item that meets a prescribed decision consistency level. The objective function is a means for navigating the search space. (i.e., a means for navigating the rows of the design space). Many, if not most, of the possible designs are infeasible because they violate design constraints, such as exceeding some pre-specified maximum length. In principle, the objective function can be applied to each possible design based on a given design space to identify ideal candidate solutions. In practice, the space of possible solutions is too large to search explicitly. Optimization methods may be used instead to solve such problems.

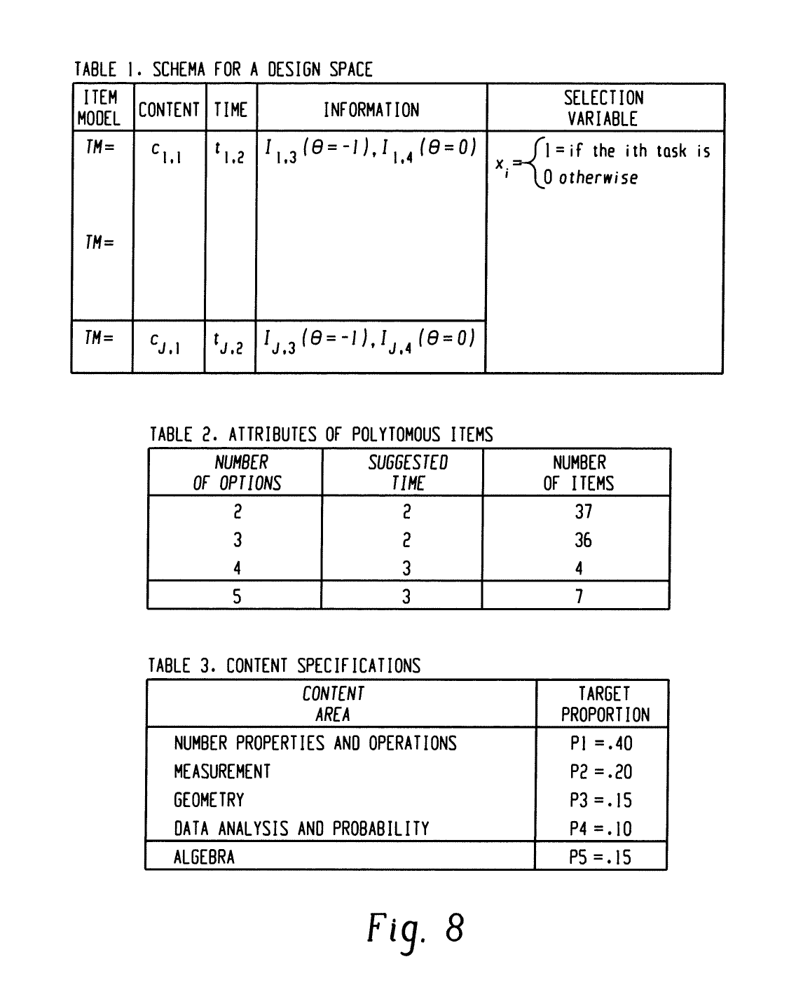

FIG. 8 depicts data tables used in an example optimization. Eighty-four math polytomously scored constructed response task models were used. The schema for the design space is seen in Table 1. The first column is the identification of the possible 84 item models that would be based on the actual items. The second column indicates the domain the item model belongs to. The next column indicates the time allowance of the task model. The next set of columns corresponds to the item level information at three values ofability expressed on a θ metric, namely −1, 0, and 1. For purposes of the illustration it was assumed that cutscores occur at those values of ability. The last column takes the value 1 or 0 depending on whether the task model is included in the form model or not. Table 2 shows the number of polytomous items, their score categories, and time. For this example, the objective function is defined as the match of the proportion of items from five content areas, that is, to minimize the discrepancy between the content coverage of a candidate form and the coverage called for by a given blueprint. The target proportions are given by the blueprint for the assessment and are shown in Table 3. The objective function can be defined as a measure of construct representation, CR:

$$CR = {\sum }_{c} ( {p}_{c} - {P}_{c} ) c = 1 , … 5 ,$$

where Pc refers to the target proportion and p_{c} refers to the actual proportion in a candidate form.

Maximizing construct representation by minimizing the discrepancies of the content against the target is desirable, but restrictions may be needed to obtain an operationally feasible form model. Such restrictions, or constraints, could include desirable characteristics of the distribution of task models, the maximum testing time, and co-occurrence constraints where certain task models may appear or not appear with each other. For illustration purposes, attention is limited to the time demands and the information function at the cutscores.

To express that a form should not be longer than a class period of 50 minutes, for example, for a form consisting of J item models, the following constraint can be defined, FT:

$$FT = {\sum }_{j ∈ ( 1 … J ]} {x}_{j} {t}_{j} .$$

For purposes of illustration, it can be assumed that three cutscores have been defined at values of θ=−1, 0, and 1. It can also be assumed that the information function values at those values of ability are known from suitably calibrated item parameters. The information function for the polytomous items can be based on the generalized partial credit model and is given as,

$${I}_{j} ( θ ) = {D}^{2} {a}_{j}^{2} [ {\sum }_{k = 0}^{{m}_{j}} {k}^{2} {P}_{jk} ( θ ) - {( {\sum }_{k = 0}^{{m}_{j}} {kP}_{jk} ( θ ) )}^{2} ] .$$

The information factors can be coded as separate constraints:

$${\sum }_{J} {x}_{j} {I}_{j , 3} ( θ = - 1 ) \geq 6 , \\ {\sum }_{J} {x}_{j} {I}_{j , 4} ( θ = - 0 ) \geq 8 , \\ {\sum }_{J} {x}_{j} {I}_{j , 5} ( θ = 1 ) \geq 8.$$

A rationale for the choice of information values is to control a level of decision consistency. An IRT approach to estimate a proportion of misclassified students between two adjacent classifications given a set of item parameter estimates and a cutscore expressed on the theta metric and the conditional standard error of measurement at the cutscore may be desirable. Given item parameter estimates, the conditional standard error of measurement at a cutscore θ_{c} is given by

$$csem ( {θ}_{c} ) = \frac{1}{\sqrt{I ( {θ}_{c} )}} ,$$

where θ_{c} is the value of θ corresponding to a cutscore. That is, by specifying a design that meets information targets, the corresponding conditional standard error of measurement is specified resulting in decision consistency.

With reference back to FIG. 5, in addition to providing and generating exam questions 516, the adaptive test generator scores received exam answers 506, as depicted at 518. Scoring of multiple choice, true/false, and other question types having a limited universe of correct answers can be accomplished via a comparison to a data table containing correct answers or other method. Scoring open ended constructed responses, which often have several, if not many, correct answers or answers worth partial credit, may require more processing. Traditionally, constructed responses are human scored. However, such a configuration is not amenable to an adaptive test, where decisions regarding which questions are to be presented to an examinee must be made during an exam. Thus, automated constructed response scoring may be incorporated into the adaptive test generator 502.

Automated scoring can be implemented into the adaptive test generator 502 in a variety of ways. For example, Educational Testing Service® offers its m-rater™ product that can automatically score mathematics expressions and equations, as well as some graphs. For example, if the key to an item is

$$\frac{3}{2} x + 2 ,$$

m-rater can score student responses such as

$$\frac{( 4 + 3 x )}{2}$$

or any other mathematical equivalent as correct. m-rater™ can also assess numerical equivalence. For example, if the key to an item is 3/2, responses such as 1.5, 6/4, or any other numerical equivalent will be scored as correct. Another product of Educational Testing Service®, c-rater™, can automatically score short text responses. In general, automated scoring of constructed responses can be carried out using approaches known to the those of ordinary skill in the art such as those described in U.S. Pat. No. 6,796,800, entitled “Methods for Automated Essay Analysis” and U.S. Pat. No. 7,392,187, entitled “Method and System for the Automatic Generation of Speech Features for Scoring High Entropy Speech,” the entirety of both of which is herein incorporated by reference.

An additional level of complexity is added when on-the-fly question generation is incorporated into an adaptive test that utilizes constructed responses. To score constructed responses, a scoring key for the constructed response may be generated when the question that requests the constructed response is generated. For example, for a text constructed response, a concept-based scoring rubric may be generated. Certain key concepts may provide evidence for a particular score level, when present in an examinee's response. Because there are often multiple approaches to solving a problem or providing an explanation, a concept-based scoring rubric specifies alternative sets of concepts that should be present at a particular score level. A next step may be to human-score a sample of student responses in accordance with the concept-based scoring rubric. Typically, this sample consists of 100-200 responses, and the responses are scored by two human scorers working independently. The concept-based scoring rubric and the human-scored responses may be loaded into a computer for generation of a scoring model that provides scoring that is consistent with the human-score sample.

To score mathematics based constructed responses, a first step is to define a concept-based rubric. A second step is to create simulated scored student responses. Because mathematic constructed responses are expressed in mathematical form, it may be more straightforward to predict representative student responses, and simulating them is typically sufficient for the purpose of building a model. The concept-based rubric and the scored responses are used to build the scoring model.

Following administration of a number of exam questions 504 and receipt and scoring associated exam answers 506, the adaptive test generator 502 assigns examinees to scoring level or otherwise provides examinees a score at 520. The scores assigned by the adaptive test generator 502 may be stored in the one or more data stores 508, as indicated at 514.

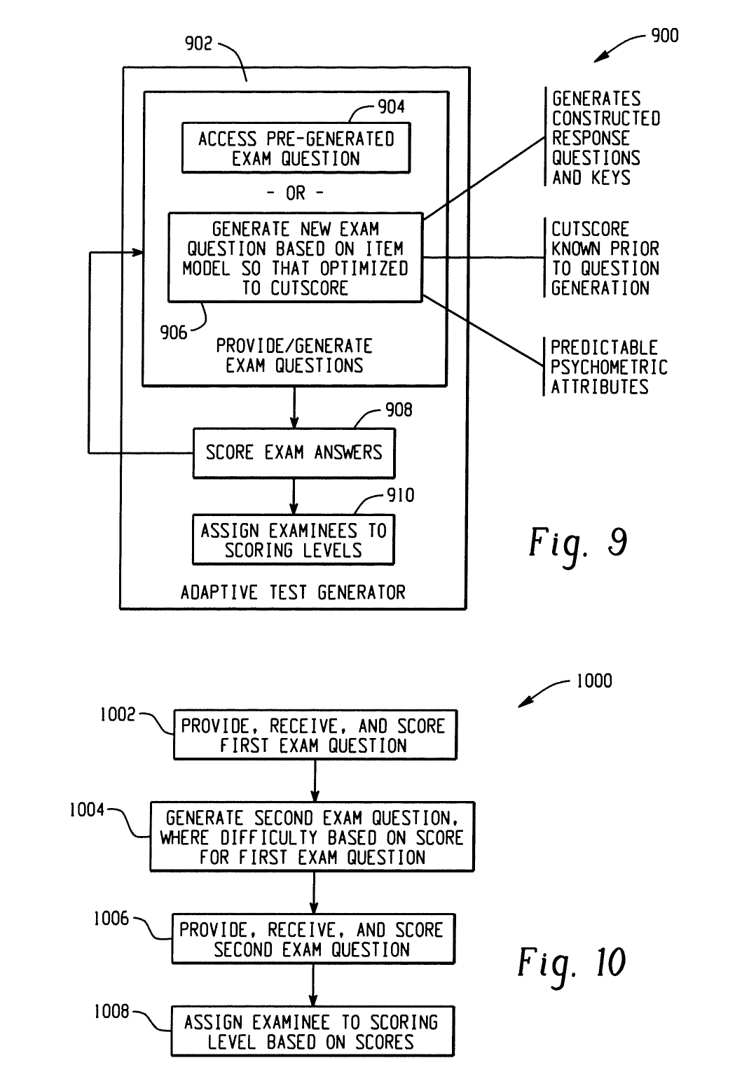

FIG. 9 is a block diagram depicting the adaptive test generator 902 providing and generating exam questions. The adaptive test generator 902 may access a data store to provide a pre-generated exam question to an examinee, as indicated at 904. Alternatively, the adaptive test generator may generate a new exam question that is optimized to a cutscore, as indicated at 906. The decision of whether to access a pre-generated exam question or generate a new exam question may be based on the contents of a form model that is directing the adaptive test generator 902 as to which questions should be provided. For example, the form model for a portion of an exam (e.g., the E stage 410 depicting in FIG. 4) may dictate that a question requesting a constructed response should be generated. The adaptive test generator generates the constructed response question and an associated key. The constructed response question may be optimized based on a cutscore for the portion of the adaptive examination for which the question is being generated, where the cutscore is known prior to generation of the question. The optimization of the constructed response question causes the generated question to have predictable psychometric attributes. The question is provided to the examinee, a received response is scored at 908, and the examinee is assigned to a scoring level or otherwise provided a score at 910.

It should be noted that questions at a stages in an adaptive test may be provided in a variety of ways. For example, each stage could consist of a single question, where an examinee is routed based on a score generated for the examinee's response to that single question. Such a configuration could be viewed as having many stages. Alternatively, a block of questions may be provided at a single stage, and the examinee may be routed based on their scores for that block of multiple questions at the stage. The questions of such a stage could be dictated by a form model. As another example, blocks of questions for a stage could be of varying length, with the length of a block provided being determined based on an IRT ability estimate. In other words, a number of questions are provided at a stage until a degree of confidence is reached in the forthcoming classification for the next stage.

Communications between the examinee and the adaptive test generator 902 (i.e., the modality of the stimulus and response) may take a variety of forms or combination of forms in addition to the transmission of questions and receipt of answers using text or numbers as described above. For example, communications may be performed using audio and speech. A test item prompt may be provided to an examinee via recorded speech or synthesized speech. An examinee could respond vocally, and the examinee's speech could be captured and analyzed using speech recognition technology. The content of the examinee's speech could then be evaluated and scored, and a next question could be provided to the examinee based on the determined score. Communications may be performed numerically, graphically, aurally, in writing, or in a variety of other forms.

FIG. 10 depicts an exemplary computer-implemented method of assigning an examinee to one of a plurality of scoring levels based on an adaptive exam that generates one or more questions of the exam subsequent to the start of administration of the exam to the examinee. At 1002, a first exam question is provided to the examinee, a first exam answer is received from the examinee, and a score is generated for the received first exam answer, where the first exam question requests a constructed response from the examinee, and the first exam answer is a constructed response. At 1004, a second exam question is generated subsequent to receiving the first exam answer, where a difficulty of the second exam question is based on the score for the first exam answer. At 1006, the second exam question is provided to the examinee, a second exam answer is received from the examinee, and a score is generated for the second exam answer. At 1008, the examinee is assigned to one of the plurality of scoring levels based on the score for the first exam answer and the second exam answer. The examinee is excluded from assignment to one or more of the plurality of scoring levels based on the first exam answer without consideration of the second exam answer.

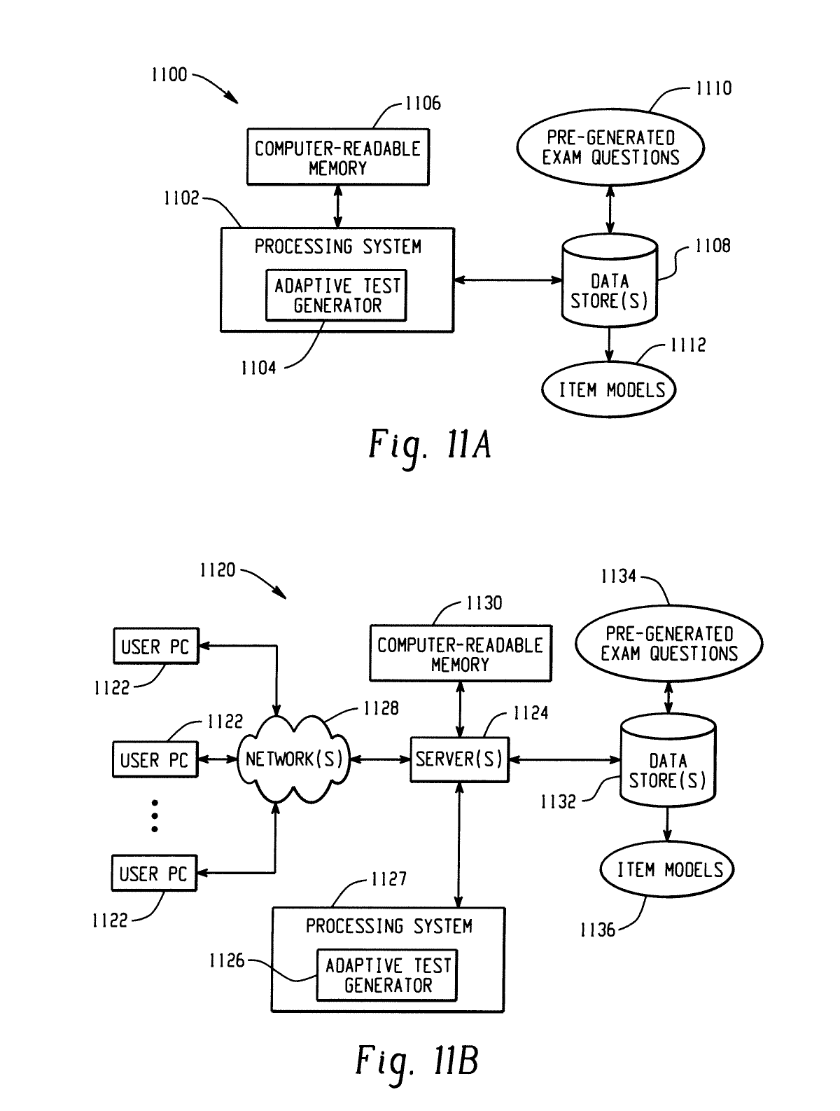

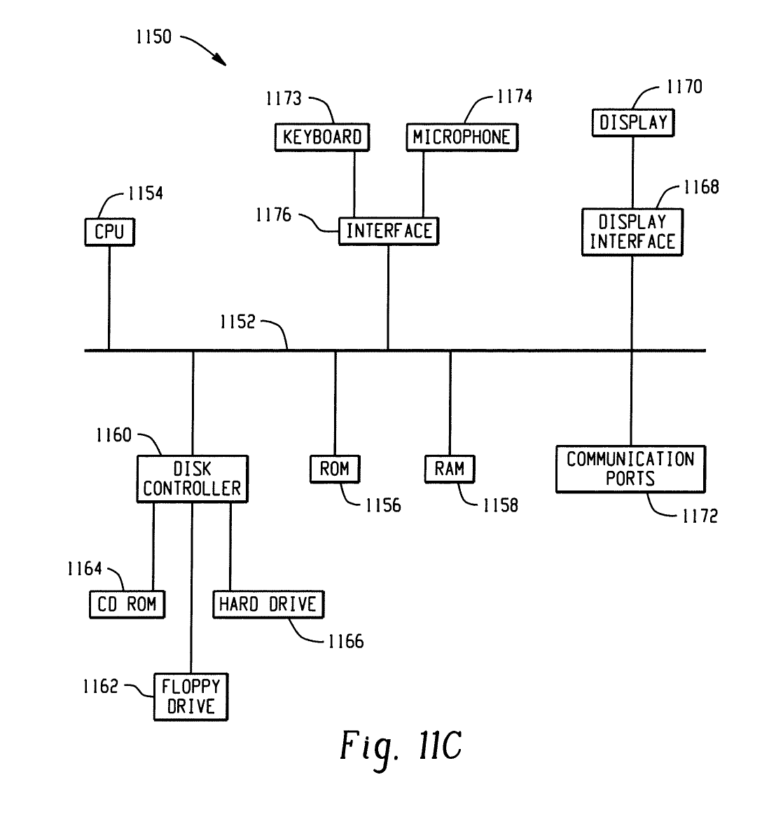

FIGS. 11A, 11B, and 11C depict example systems for an adaptive test generator. For example, FIG. 11A depicts an exemplary system 1100 that includes a stand alone computer architecture where a processing system 1102 (e.g., one or more computer processors) includes a system for generating an adaptive test 1104 being executed on it. The processing system 1102 has access to a computer-readable memory 1106 in addition to one or more data stores 1108. The one or more data stores 1108 may contain pre-generated exam questions 1110 as well as item models 1112.

FIG. 11B depicts an exemplary system 1120 that includes a client server architecture. One or more user PCs 1122 access one or more servers 1124 running a system for generating an adaptive test 1126 on a processing system 1127 via one or more networks 1128. The one or more servers 1124 may access a computer readable memory 1130 as well as one or more data stores 1132. The one or more data stores 1132 may contain pre-generated exam questions 1134 as well as item models 1136.

FIG. 11C shows a block diagram of exemplary hardware for a stand alone computer architecture 1150, such as the architecture depicted in FIG. 11A, that may be used to contain and/or implement the program instructions of system embodiments of the present invention. A bus 1152 may serve as the information highway interconnecting the other illustrated components of the hardware. A processing system 1154 labeled CPU (central processing unit) (e.g., one or more computer processors), may perform calculations and logic operations required to execute a program. A processor-readable storage medium, such as read only memory (ROM) 1156 and random access memory (RAM) 1158, may be in communication with the processing system 1154 and may contain one or more programming instructions for assigning an examinee to one of a plurality of scoring levels based on an adaptive exam. Optionally, program instructions may be stored on a non-transitory computer readable storage medium such as a magnetic disk, optical disk, recordable memory device, flash memory, or other physical storage medium. Computer instructions may also be communicated via a communications signal, or a modulated carrier wave, so as to be down-loaded onto a non-transitory computer-readable storage medium.

A disk controller 1160 interfaces with one or more optional disk drives to the system bus 1152. These disk drives may be external or internal floppy disk drives such as 1162, external or internal CD-ROM, CD-R, CD-RW or DVD drives such as 1164, or external or internal hard drives 1166. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 1160, the ROM 1156 and/or the RAM 1158. Preferably, the processor 1154 may access each component as required.

A display interface 1168 may permit information from the bus 1152 to be displayed on a display 1170 in audio, graphic, or alphanumeric format. Communication with external devices may optionally occur using various communication ports 1172.

In addition to the standard computer-type components, the hardware may also include data input devices, such as a keyboard 1173, or other input device 1174, such as a microphone, remote control, pointer, mouse and/or joystick.

This written description uses examples to disclose the invention, including the best mode, and also to enable a person skilled in the art to make and use the invention. The patentable scope of the invention may include other examples. For example, the systems and methods may include data signals conveyed via networks (e.g., local area network, wide area network, interne, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It may be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

The disclosure has been described with reference to particular exemplary embodiments. However, it will be readily apparent to those skilled in the art that it is possible to embody the disclosure in specific forms other than those of the embodiments described above. The embodiments are merely illustrative and should not be considered restrictive. The scope of the disclosure is given by the appended claims, rather than the preceding description, and all variations and equivalents which fall within the range of the claims are intended to be embraced therein.

What is claimed is:

1. A computer-implemented method of assigning an examinee to one of a plurality of scoring levels based on an adaptive exam that generates one or more questions of the exam subsequent to the start of administration of the exam to the examinee, the method comprising:
providing a first exam question to the examinee;
receiving a first exam answer from the examinee, wherein the first exam question requests a constructed response from the examinee and wherein the first exam answer is a constructed response;
generating a score for the first exam answer;
generating a second exam question subsequent to receiving the first exam answer, wherein a difficultly of the second exam question is based on the score for the first exam answer;
providing the second exam question to the examinee;
receiving a second exam answer from the examinee;
generating a score for the second exam answer; and
assigning the examinee to one of the plurality of scoring levels based on the score for the first exam answer and the score for the second exam answer.

2. The method of claim 1, wherein the second exam question requests a constructed response.

3. The method claim 1, wherein a constructed response is other than a multiple choice answer and other than a true/false answer.

4. The method of claim 1, wherein additional exam questions are provided to the examinee, wherein one of the additional exam questions is generated prior to the start of the administration of the examination.

5. The method of claim 1, wherein the second exam question is generated according to an item model.

6. The method of claim 5, wherein the item model identifies variables of the second exam question and constraints on values for the variables of the second exam question.

7. The method of claim 6, wherein the constraints force the second exam question to have a predictable psychometric attribute.

8. The method of claim 7, wherein the predictable psychometric attribute provides a statistical basis for the assignment of the examinee to one of the plurality of scoring levels with a degree of certainty.

9. The method of claim 7, wherein the psychometric attribute is a probability of correctly classifying the examinee into one of the plurality of scoring levels.

10. The method of claim 5, wherein the second exam question requests a constructed response, wherein generating the second exam question according to the item model includes generating a key for scoring the second exam question.

11. The method of claim 1, wherein the plurality of scoring levels are delimited according to cutscores that are known prior to generation of the second exam question.

12. The method of claim 11, wherein the first question is generated to be answered correctly by an examinee who is proficient at a subject matter being tested and to be answered incorrectly by an examinee who is not proficient at the subject matter being tested.

13. The method of claim 12, wherein the second question is generated according to one of a plurality of item models that identify variables of the second exam question and constraints on values for the variables of the second exam question, wherein when an examinee is deemed proficient at the subject matter being tested based on the first exam answer, an item model is selected that generates the second question to be answered correctly by an examinee who is advanced at the subject matter being tested and to be answered incorrectly by an examinee who is proficient at the subject matter being tested.

14. The method of claim 12, wherein the second question is generated according to one of a plurality of item models that identify variables of the second exam question and constraints on values for the variables of the second exam question, wherein when an examinee is deemed not proficient at the subject matter being tested based on the first exam answer, an item model is selected that generates the second question to be answered correctly by an examinee who has a basic understanding of the subject matter being tested and to be answered incorrectly by an examinee who has a below basic understanding of the subject matter being tested.

15. The method of claim 1, wherein multiple exam questions including the second exam question are provided to the examinee subsequent to receiving the first exam answer;
wherein the multiple exam questions are dictated by a form model;
wherein for each of the multiple exam questions, the form model either:
identifies a pre-generated exam question; or
identifies an item model for generating that exam question.

16. The method of claim 1, further comprising providing a score to the examinee based on the scoring level to which the examinee is assigned before the examinee leaves a testing computer terminal.

17. The method of claim 1, wherein the examinee is excluded from assignment to one or more of the plurality of scoring levels based on the first exam answer without consideration of the second exam answer

18. A computer-implemented system for assigning an examinee to one of a plurality of scoring levels based on an adaptive exam that generates one or more questions of the exam subsequent to the start of administration of the exam to the examinee, the system comprising:
a processor; and
a computer-readable memory encoded with instructions for commanding the processor to execute steps including:
providing a first exam question to the examinee;
receiving a first exam answer from the examinee wherein the first exam question requests a constructed response from the examinee and wherein the first exam answer is a constructed response;
generating a score for the first exam answer;
generating a second exam question subsequent to receiving the first exam answer, wherein a difficultly of the second exam question is based on the score for the first exam answer;
providing the second exam question to the examinee;
receiving a second exam answer from the examinee;
generating a score for the second exam answer; and
assigning the examinee to one of the plurality of scoring levels based on the score for the first exam answer and the score for the second exam answer.

19. The system of claim 18, wherein the second exam question requests a constructed response.

20. The system claim 18, wherein a constructed response is other than multiple choice answer and other than true/false answer.

21. The system of claim 18, wherein additional exam questions are provided to the examinee, wherein one of the additional exam questions is generated prior to the start of the administration of the examination.

22. The system of claim 18, wherein the second exam question is generated according to an item model.

23. The system of claim 22, wherein the item model identifies variables of the second exam question and constraints on values for the variables of the second exam question.

24. The system of claim 23, wherein the constraints force the second exam question to have a predictable psychometric attribute.

25. The system of claim 24, wherein the predictable psychometric attribute provides a statistical basis for the assignment of the examinee to one of the plurality of scoring levels with a degree of certainty.

26. The system of claim 24, wherein the psychometric attribute is a probability of correctly classifying the examinee into one of the plurality of scoring levels.

27. The system of claim 22, wherein the second exam question requests a constructed response, wherein generating the second exam question according to the item model includes generating a key for scoring the second exam question.

28. The system of claim 18, wherein the plurality of scoring levels are delimited according to cutscores that are known prior to generation of the second exam question.

29. The system of claim 28, wherein the first question is generated to be answered correctly by an examinee who is proficient at a subject matter being tested and to be answered incorrectly by an examinee who is not proficient at the subject matter being tested.

30. The system of claim 29, wherein the second question is generated according to one of a plurality of item models that identify variables of the second exam question and constraints on values for the variables of the second exam question, wherein when an examinee is deemed proficient at the subject matter being tested based on the first exam answer, an item model is selected that generates the second question to be answered correctly by an examinee who is advanced at the subject matter being tested and to be answered incorrectly by an examinee who is proficient at the subject matter being tested.

31. The system of claim 29, wherein the second question is generated according to one of a plurality of item models that identify variables of the second exam question and constraints on values for the variables of the second exam question, wherein when an examinee is deemed not proficient at the subject matter being tested based on the first exam answer, an item model is selected that generates the second question to be answered correctly by an examinee who has a basic understanding of the subject matter being tested and to be answered incorrectly by an examinee who has a below basic understanding of the subject matter being tested.

32. The system of claim 18, wherein multiple exam questions including the second exam question are provided to the examinee subsequent to receiving the first exam answer;
wherein the multiple exam questions are dictated by a form model;
wherein for each of the multiple exam questions, the form model either:
identifies a pre-generated exam question; or
identifies an item model for generating that exam question.

33. The system of claim 18, further comprising providing a score to the examinee based on the scoring level to which the examinee is assigned before the examinee leaves a testing computer terminal.

34. The system of claim 18, wherein the examinee is excluded from assignment to one or more of the plurality of scoring levels based on the first exam answer without consideration of the second exam answer

35. A computer-readable memory encoded with instructions for commanding a data processor to execute a method of assigning an examinee to one of a plurality of scoring levels based on an adaptive exam that generates one or more questions of the exam subsequent to the start of administration of the exam to the examinee, the method comprising:
providing a first exam question to the examinee;
receiving a first exam answer from the examinee;
wherein the first exam question requests a constructed response from the examinee and wherein the first exam answer is a constructed response;
generating a score for the first exam answer;
generating a second exam question subsequent to receiving the first exam answer, wherein a difficultly of the second exam question is based on the score for the first exam answer;
providing the second exam question to the examinee;
receiving a second exam answer from the examinee;
generating a score for the second exam answer;
assigning the examinee to one of the plurality of scoring levels based on the score for the first exam answer and the score for the second exam answer.
